(19) United States
(12) Patent Application Publication
(10) Pub. No.: US 2002/0080567 A1
(43) Pub. Date: Jun. 27, 2002

(54) HARD CASE FOR HANDHELD COMPUTER SYSTEM

(76) Inventors: Martin Bone, San Francisco, CA (US); Sam Truslow, San Francisco, CA (US); Dennis Boyle, Palo Alto, CA (US)

Correspondence Address: GARY CARY WARE & FREIDENRICH, 1755 EMBARCADERO, PALO ALTO, CA, 94303-3340, US

(21) Appl. No.: 09/747,750

(22) Filed: Dec. 21, 2000

(51) Int. Cl. G06F 1/16

(52) U.S. Cl. 361/683

(57) ABSTRACT

A hard case for a handheld computer system permits the hard case to remain attached to the handheld computer system in both a locked/storage position and a synchronization position. The hard case may be slid in relation to the handheld computer system to expose the electrical contacts of the handheld computer system. The hard case may also have a notched hinge that permits the infrared port of the handheld computer system to be used while the hard case is in the locked/storage position.

### BACKGROUND OF THE INVENTION

This invention relates generally to a case that protects a computer product and in particular to a hard case for protecting small handheld computer systems, such as personal digital assistants (PDAs), pocket personal computers (PCs) and the like. Examples of these small handheld computer systems are made by Palm Inc®, Handspring Inc.®, Casio®, Microsoft® and many others.

These small handheld computer systems permit a user to carry a computer system in his pocket, purse or briefcase that can handle many different tasks. For example, many of the handheld computer systems have the ability to store calendar appointments of the user, to store tasks to be completed by the user (often called To Dos), to store information in a memo pad for jotting notes and to store information in an address book for keeping track of the names, addresses, etc. of the business and personal contacts of the user. Some handheld computer systems permit the user to compose and respond to electronic messages.

Most handheld computer systems permit the user to communicate data in the handheld device to another computer, such as a desktop personal computer, a server or the like, and vice versa. This process is sometimes called synchronization in that the data stored in a program on the computer can be synchronized with the data in the handheld computer system. For example, the appointment data entered on the handheld computer system may be loaded into the computer and the appointments entered into the computer may be loaded into the handheld computer system. These handheld computer systems have become very widely used by different people who want some of the capabilities of a desktop computer or laptop computer, but do not want to have to transport the desktop or laptop computer.

These small handheld computer systems are typically designed to be small and lightweight so that they can be carried by the user. A consequence of this design choice is that these small handheld computer systems are more susceptible to damage since they can be dropped and damaged due to their small size. In addition, due to their small size and light weight, the handheld computer systems are built with thinner walls and the like so that the sensitive electrical components are more likely to be damaged when the handheld computer systems is dropped. In addition, the glass touchscreen of these small handheld computer systems is very delicate and susceptible to damage. Furthermore, the touchscreen is susceptible to scratches and wear during normal usage.

To help protect these handheld computer systems, various different cases that attach to the handheld computer system have been developed which help to protect the handheld computer systems from damage. The problem with most current protective cases is that the case must be removed/detached from the handheld computer systems during the synchronization process which is inconvenient for the user. In addition, the attachment mechanism that attaches the protective case to the handheld computer system may wear out and fail since the handheld computer system must be removed from the case before the synchronization and then put back into the case after the synchronization has been completed. Thus, it is desirable to provide a hard case for a handheld computer system which overcomes the above problem with typical cases and it is to this end that the present invention is directed.

### SUMMARY OF THE INVENTION

A hard case for a handheld computer system in accordance with the invention is provided that overcomes the above problem with typical cases and permits the handheld computer system to be left in the hard case during the synchronization process. Thus, the hard case in accordance with the invention does not need to be detached from the handheld computer system during the synchronization process. The hard case in accordance with the invention also permits the infrared (IR) port of the handheld computer system to be used even when the hard case is attached to the handheld computer system.

Thus, in accordance with the invention, a case to protect a handheld computer system is provided. The case has a bottom portion with an extended portion attached to the bottom portion that attaches the bottom portion to a handheld computer system. The case also has a first detent connected to the extended portion that holds the handheld computer system in a stored position, and a second detent connected to the extended portion that holds the handheld computer system in a synchronization position. In addition, the case may include a top portion hinged to the bottom portion at an edge wherein the top portion rotates from a first position covering a handheld computer system inserted into the case to a second position wherein the handheld computer system is exposed and a hinge that rotatably connects the bottom portion to the top portion wherein the hinge has a cut-out portion adjacent to an infrared port of the handheld computer system to permit the infrared port to be used while the handheld computer system is in the case.

In accordance with another aspect of the invention, a case to protect a handheld computer system is provided. The case has a bottom portion that is attached to the handheld computer system, and a latch means connected to the bottom portion that permits the handheld computer system to move from a storage position to a synchronization position.

In more detail, the case comprises a bottom portion having a first and second opposing side walls and a pair of extended portions that attach the bottom portion to a handheld computer system wherein a first extended portion is attached to the first side wall and a second extended portion is attached to the second side wall. The case further comprises a first set of detents having a first detent connected to the first extended portion and a second detent connected to the second extended portion that hold the handheld computer system in a stored position, and a second set of detents having a third detent connected to the first extended portion and a fourth detent connected to the second extended portion that hold the handheld computer system in a synchronization position. The hard case in accordance with the invention may further include a third set of detents that keep the handheld computer system from inadvertently falling out of the hard case or being inadvertently ejected out of the case when the user moves from the storage position to the synchronization position.

### BRIEF DESCRIPTION OF THE DRAWINGS

FIG. 1 illustrates a preferred embodiment of a hard case in accordance with the invention;

FIG. 2 illustrates the hard case with a handheld computer system in a storage/locked position;

FIG. 3 illustrates the hard case with a handheld computer system in a synchronization position;

FIG. 4 is a back view of the handheld computer system and case in the synchronization position;

FIGS. 5a and 5b illustrate a typical synchronization cradle into which the handheld computer system is placed and the handheld computer system being placed into the cradle, respectively;

FIG. 6a illustrates a typical handheld computer system;

FIG. 6b illustrates more details of the handheld computer system;

FIGS. 7a and 7b illustrate more details of the hard case when the handheld computer system is in a storage/locked position;

FIGS. 8a and 8b illustrate more details of the hard case when the handheld computer system is moved from the storage position to the synchronization position;

FIGS. 9a and 9b illustrate more details of the hard case when the handheld computer system is in a synchronization position; and

FIG. 10 illustrates the notched hinge in accordance with the invention that permits operation of the IR port.

### DETAILED DESCRIPTION OF A PREFERRED EMBODIMENT

The invention is particularly applicable to a hard case for a personal digital assistant, such as the Handspring® Visor® and it is in this context that the invention will be described. It will be appreciated, however, that the hard case in accordance with the invention has greater utility since the hard case may be used with various different handheld computer systems.

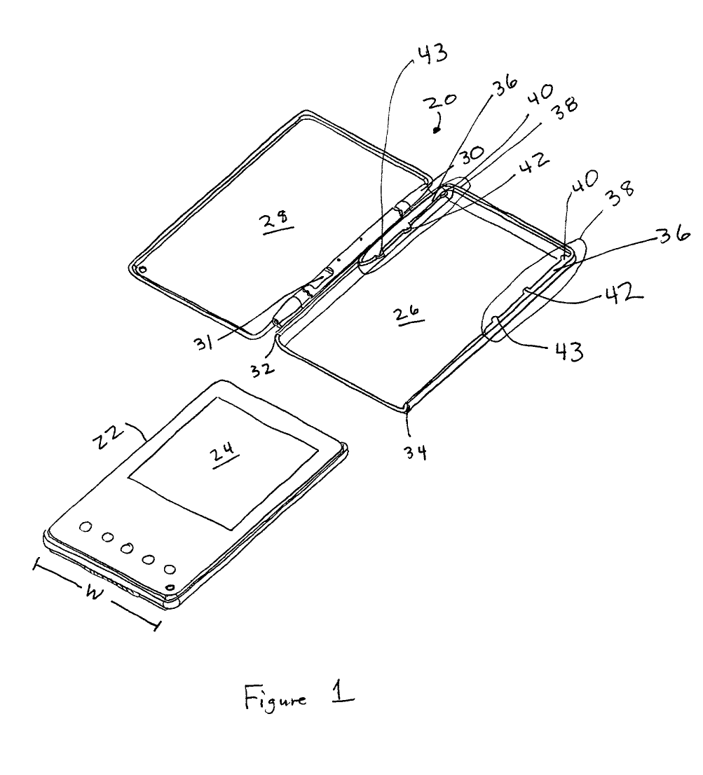

FIG. 1 illustrates a preferred embodiment of a hard case 20 in accordance with the invention designed for a personal digital assistant (PDA) 22. The hard case is designed to protect the PDA 22 from various different types of damage, such as scratches to a display 24 of the PDA or damage caused by the dropping of the PDA 22. The hard case 20 may be made of any suitable material which will absorb some of the impact and protect the PDA in general. A preferred material may be a hard, yet lightweight plastic material or a lightweight metal material.

The hard case 20 may include a bottom portion 26 and a top portion 28 wherein the two portions are rotatably connected together by a hinge 30. The PDA 22 may slide and lock into one of three positions in the bottom portion 26 as described below and then the top portion may rotate about the hinge 30 from an open position so that the user may use the functions of the PDA as shown in FIG. 1 to a closed position wherein the top portion covers the PDA 22 and its display 24 to protect them from damage. The top and bottom portions may be releasably secured together in some well known manner. The top and bottom portions may be designed so that the PDA 22 rests snugly within the hard case when the top portion is in the closed position. In accordance with one aspect of the invention, the hinge 30 may include a notch 31 that permits the infrared port of the PDA to be operated even when the hard case is in the closed/storage position as described below with reference to FIG. 10.

The bottom portion 26 may further include first and second side wall portions 32, 34 that are substantially parallel to each other and spaced apart from each other by a distance approximately equal to the width, W, of the PDA 22. Each side wall portion may further include an extended portion 36 that extends out from the side wall towards the PDA and may have one or more sets of detents 38 which hold the PDA at one or more different positions, such as a closed/locked position, a synchronization position and a safety position as described below in more detail. In a preferred embodiment, there may be three sets of detents that may include a first set of detents 40, a second set of detents 42 and a third set of detents 43. The PDA 22 may be held in a first locked position by the first detents 40 of the extended portions 36 and the PDA may be held in a second synchronization position by the second detents 42 of the extended portions 36. The third detents 43 ensure that the PDA does not inadvertently fall out of the hard case or is not inadvertently ejected out of the hard case as the user is trying to move the hard case from the storage position to the synchronization position. In general, the detents 40, 42, 43 may cooperate with a pocket region in the PDA case to secure the PDA in the locked position, the synchronization position or the safety position as described in more detail below.

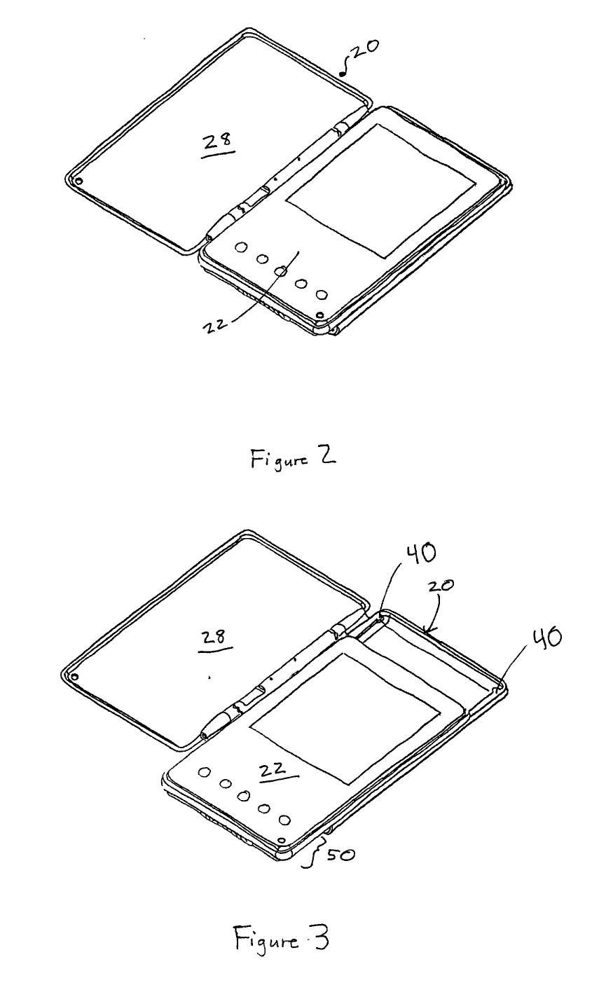

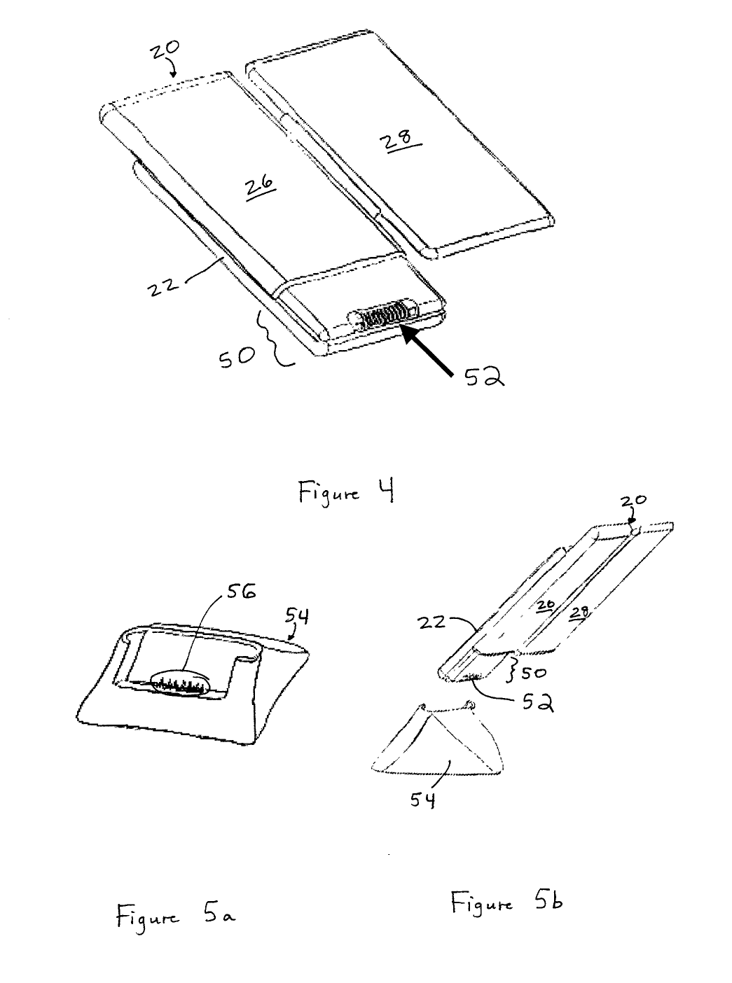

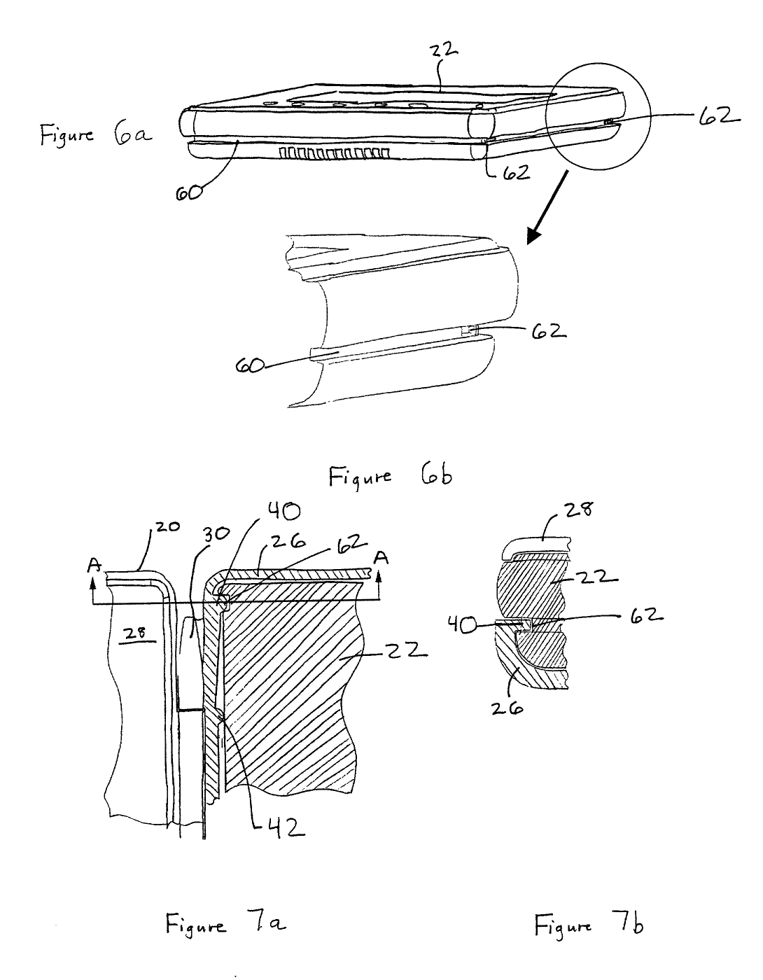

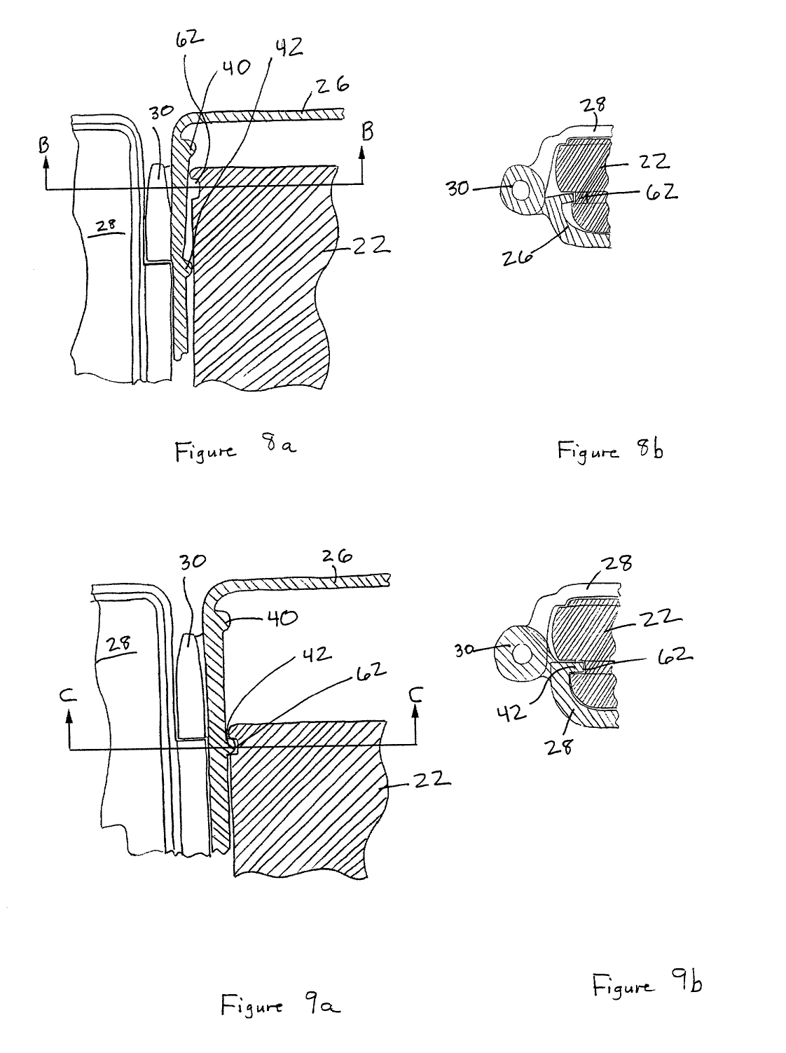

FIG. 2 illustrates the hard case 20 with the handheld computer system 22 in a storage/locked position wherein the handheld computer system is within the hard case and therefore protected from damage. In FIG. 2, the top portion 28 of the hard case 20 is open so that the user may operate the PDA while the PDA is within the hard case. FIG. 3 illustrates the hard case 20 with the handheld computer system 22 in a synchronization position wherein a predetermined portion 50 of the handheld computer system extends beyond the bottom of the hard case so that the synchronization may occur as described in more detail with reference to FIGS. 4, 5a and 5b. In the synchronization position, the first detents 40 are exposed since the PDA has been slid down relative to the hard case. To move the hard case in accordance with the invention from the storage/locked position to the synchronization position, a user may apply force to slide the hard case relative to the PDA as described below in more detail.

FIG. 4 is a back view of the handheld computer system 22 and hard case 22 in the synchronization position wherein a set of electrical contacts 52 are exposed since the predetermined portion 50 of the handheld computer system extends beyond the hard case. In FIG. 5a, a typical synchronization cradle 54 into which the handheld computer system is placed during the synchronization is shown. The cradle 54 may include a set of electrical contacts 56 located near the bottom of the cradle which must make electrical contact with the set of contacts 52 on the handheld computer system (shown in FIG. 4) during the well known synchronization process. To facilitate the contact between the two sets of electrical contacts 52, 54 while maintaining the attachment of the hard case to the PDA during the synchronization, the predetermined portion 50 of the PDA is exposed. The mechanism in accordance with the invention for permitting the hard case to be in a locked/storage position and in a synchronization position will now be described in more detail.

FIG. 6a illustrates more details of the handheld computer system 22 wherein the handheld computer system 22 may have a valley region 60 that runs along each side of the PDA. At the top of each valley, the valley may have a pocket region 62 (as shown in FIG. 6b). The pocket region 62 may preferably by rectangular shaped. Now, the interaction of the pocket region with the detents of the hard case will be described.

FIGS. 7a and 7b illustrate more details of the hard case when the handheld computer system is in a storage/locked position wherein FIG. 7a is a top cutaway view of the PDA 22 and the hard case 20 and FIG. 7b is a section view along line A-A of FIG. 7a. In particular, as shown in FIGS. 7a and 7b, the first detent 40 is seated in the pocket region 62 of the PDA so that the PDA is held in the storage/locked position. The second detent 42 slides along the outside of the PDA 22 while in the locked position. In accordance with the invention, the material of the hard case 20 is flexible enough to permit the first detent 40 to be seated in the pocket region 62 while the second detent 42 slides along the PDA. In this position, the PDA may be used by the user while being protected from damage.

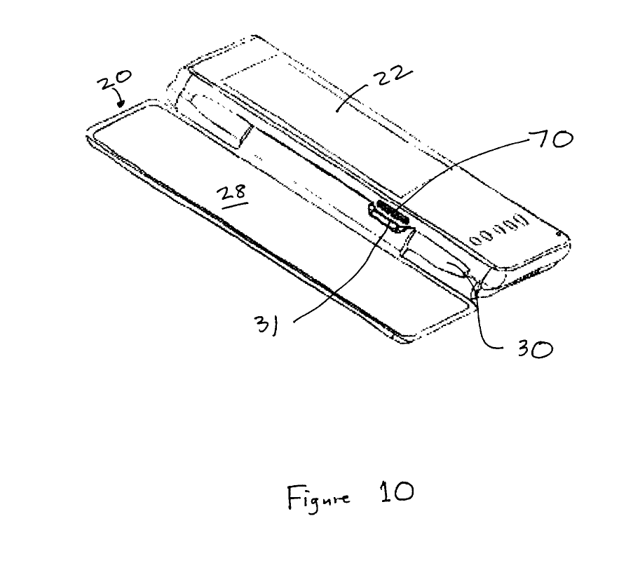

FIGS. 8a and 8b illustrate more details of the hard case when the handheld computer system 22 is being moved by the user from the storage position to the synchronization position wherein FIG. 8a is a top cutaway view and FIG. 8b is a sectional view along line B-B of FIG. 8a. As shown, the first detent 40 is exposed since the PDA has been slid past the detent and the second detent 42 is sliding on the PDA case so that no detent is seated in the pocket region 62. FIGS. 9a and 9b illustrate more details of the hard case when the handheld computer system is in a synchronization position wherein the second detent 42 is seated in the pocket region 62 and the first detent 40 is exposed as shown. In this position, the user may set the exposed bottom portion of the PDA with the contacts into the cradle and synchronize the PDA with a desktop computer or some other computer system while maintaining the hard case attached to the PDA. The PDA in the safety position is not shown wherein the third set of detents 43 are seated in the pocket regions of the PDA. Thus, in accordance with the invention, the PDA with the hard case attached may be utilized by the user in the storage position and in the synchronization position. Now, another aspect of the hard case in accordance with the invention will be described.

FIG. 10 illustrates the hinge 30 in accordance with the invention with a notch 31 that permits operation of the infrared (IR) port of the PDA when the hard case is in the storage/locked position. As shown, an ID port 70 of the PDA 22 is located on the side of the PDA. To permit the IR port to be utilized when the hard case is in storage/locked position, the notch 31 is aligned with the IR port 70 as shown. Thus, when the top portion 28 of the hard case is open as shown in FIG. 10 or closed, the IR port of the PDA may be used.

While the foregoing has been with reference to a particular embodiment of the invention, it will be appreciated by those skilled in the art that changes in this embodiment may be made without departing from the principles and spirit of the invention, the scope of which is defined by the appended claims.

1. A case to protect a handheld computer system, comprising:
a bottom portion;
an extended portion attached to the bottom portion that attach the bottom portion to a handheld computer system;
a first detent connected to the extended portion that holds the handheld computer system in a stored position; and
a second detent connected to the extended portion that holds the handheld computer system in a synchronization position.

2. The case of claim 1 further comprising a top portion hinged to the bottom portion at an edge wherein the top portion rotates from a first position covering a handheld computer system inserted into the case to a second position wherein the handheld computer system is exposed.

3. The case of claim 2 further comprising a hinge that rotatably connects the bottom portion to the top portion, the hinge having cut-out portion adjacent to an infrared port of the handheld computer system to permit the infrared port to be used while the handheld computer system is in the case.

4. The case of claim 1, wherein the first detent is located at a first position on the extended portion and the second detent is located at a second position on the extended portion.

5. The case of claim 4, wherein the bottom portion further comprises a first and second side wall located on opposing sides of the bottom portion and wherein the extended portion is attached to the first side wall and further comprising a second extended portion attached to the second side wall.

6. The case of claim 5, wherein the second extended portion further comprises a third detent and a fourth detent wherein the first and third detents comprise a first set of detents that hold the handheld computer system in the stored position and the second and fourth detents comprise a second set of detents that hold the handheld computer system in the synchronization position.

7. The case of claim 1, wherein the handheld computer systems comprises a personal digital assistant (PDA).

8. The case of claim 7, wherein the PDA comprises a Handspring personal digital assistant.

9. The case of claim 1 further comprising a third set of detents connected to the extended portion that hold the handheld computer system in a safety position and prevent the handheld computer system for slipping out of the case.

10. A case to protect a handheld computer system, comprising:
a bottom portion;
an attachment means that attaches the bottom portion to a handheld computer system; and
a latch means connected to the attachment means, the latch means permitting a user to move the handheld computer system from a storage position to a synchronization position.

11. The case of claim 10 further comprising a top portion hinged to the bottom portion at an edge wherein the top portion rotates from a first position covering a handheld computer system inserted into the case to a second position wherein the handheld computer system is exposed.

12. The case of claim 11 further comprising a hinge that rotatably connects the bottom portion to the top portion, the hinge having cut-out portion adjacent to an infrared port of the handheld computer system to permit the infrared port to be used while the handheld computer system is in the case.

13. The case of claim 10, wherein the bottom portion further comprises a first and second side walls located on opposing sides of the bottom portion and having a portion of the attachment means.

14. The case of claim 10, wherein the handheld computer systems comprises a personal digital assistant (PDA).

15. The case of claim 14, wherein the PDA comprises a Handspring personal digital assistant.

16. The case of claim 10, wherein the latch means further comprises means for holding the handheld computer system in a safety position to prevent the handheld computer system for slipping out of the case.

17. A case to protect a handheld computer system, comprising:
a bottom portion having a first and second opposing side wall;
a pair of extended portions that attach the bottom portion to a handheld computer system
wherein a first extended portion is attached to the first side wall and a second extended portion is attached to the second side wall;
a first set of detents having a first detent connected to the first extended portion and a second detent connected to the second extended portion that hold the handheld computer system in a stored position; and
a second set of detents having a third detent connected to the first extended portion and a fourth detent connected to the second extended portion that hold the handheld computer system in a synchronization position.

18. The case of claim 17 further comprising a top portion hinged to the bottom portion at an edge wherein the top portion rotates from a first position covering a handheld computer system inserted into the case to a second position wherein the handheld computer system is exposed.

19. The case of claim 18 further comprising a hinge that rotatably connects the bottom portion to the top portion, the hinge having cut-out portion adjacent to an infrared port of the handheld computer system to permit the infrared port to be used while the handheld computer system is in the case.

20. The case of claim 17, wherein the handheld computer systems comprises a personal digital assistant (PDA).

21. The case of claim 20, wherein the PDA comprises a Handspring personal digital assistant.

22. The case of claim 17 further comprising a third set of detents having a fifth detent connected to the first extended portion and a sixth detent connected to the second extended portion that hold the handheld computer system in a safety position and prevent the handheld computer system for slipping out of the case.
